(19) United States
(12) Patent Application Publication
(10) Pub. No.: US 2007/0267288 A1
(43) Pub. Date: Nov. 22, 2007

(54) Systems and methods for hydrogen storage and generation

(76) Inventor: Steven Allen Carlson, Cambridge, MA (US)

Correspondence Address: Optodot Corporation, 214 Lincoln Street, Suite 305, Allston, MA, 02134, US

(21) Appl. No.: 11/804,471

(22) Filed: May 19, 2007

Related U.S. Application Data
(60) Provisional application No. 60/802,463, filed on May 21, 2006.

(51) Int. Cl. C01B 3/00; B01J 19/08

(52) U.S. Cl. 204/157.52; 422/186

(57) ABSTRACT

Provided are systems for storing and generating hydrogen comprising a solution that comprises a reaction product of (a) a photosensitized oxidation product of methanol; and (b) a reduction product of oxygen and a photoreduced photosensitizer, wherein the system generates hydrogen gas when a basic material is added to the solution. Preferably, the photosensitizer is an anthraquinone. The photosensitizer may be dissolved in the liquid solution or may be in a solid phase in the solution. Preferably, the solid phase is a porous membrane, most preferably an inorganic oxide xerogel membrane, and the photosensitizer is complexed to an inorganic oxide xerogel material. Also provided are methods for storing hydrogen by providing methanol, an oxidative photosensitizer, oxygen, and light that is absorbed by the photosensitizer. Hydrogen gas is generated by the addition of a basic material.

### RELATED APPLICATIONS

This application claims the benefit of U.S. Provisional Patent Application No. 60/802,463, filed May 21, 2006, entitled “Systems and Methods for Hydrogen Storage and Generation,” by S. Carlson, which is incorporated herein by reference for all purposes.

### FIELD OF THE INVENTION

The present invention relates generally to the field of systems and methods for hydrogen storage and generation. More particularly, this invention pertains to methods of storing hydrogen by providing methanol, an oxidative photosensitizer, oxygen, and light that is absorbed by the photosensitizer. Hydrogen gas is generated by the addition of a basic material. The present invention also pertains to systems for storing and generating hydrogen that utilize such methods.

### BACKGROUND

Throughout this application, various patents are referred to by an identifying citation. The disclosures of the patents referenced in this application are hereby incorporated by reference into the present disclosure to more fully describe the state of the art to which this invention pertains.

Hydrogen gas is highly desirable as a fuel for vehicles and for other energy related applications such as stationary power systems and fuel cells because its combustion product is water and its fuel content in terms of weight is very high. The various fossil fuels, such as oil, natural gas, and coal, produce carbon dioxide as their main combustion product. The environmental impact of increased carbon dioxide in the atmosphere in causing global warming has led to increased efforts to find improved alternative energy sources that do not generate carbon dioxide. Besides hydrogen fuels, these alternative energy sources include photovoltaic cells, wind energy, nuclear energy, and hydroelectric power.

One of the major challenges in utilizing hydrogen as a fuel is the difficulty of storing hydrogen in a safe and economical condition. In order to use hydrogen as a fuel in vehicles, a sufficient amount of hydrogen must be provided to the vehicle. Conventional approaches include liquefying the hydrogen at very low temperatures and storing the hydrogen as a gas under high pressure, such as thousands of pounds per square inch. Liquefication and pressurization require relatively expensive processing and storage equipment and also pose safety concerns in storing and dispensing the liquid hydrogen by these approaches. The energy consumed in liquefying hydrogen gas is about 30% of the energy available from the hydrogen. Storing hydrogen under high pressure in cylinders typically results in only 1 to 4% by weight of hydrogen storage in the heavy steel or other metal cylinders. Other approaches include combining the hydrogen with another material, such as in reversible metal hydrides, at an acceptable weight percent of hydrogen that is safe and is adapted for use as a fuel. Still another approach is to convert water to hydrogen by reacting elemental metals, such as magnesium, with water as, for example, described in U.S. Pat. Nos. 6,018,091, 6,117,206, and 6,322,723, to Thomas. A number of the approaches to store, supply, and generate hydrogen are described in U.S. Pat. Nos. 6,745,801 and 6,886,609, both to Cohen et al.

It would be advantageous if a safe and convenient method of storing and generating hydrogen gas were available for use in a variety of energy related applications such as vehicles and fuel cells. It would be particularly advantageous if this method had the flexibility to store the hydrogen gas in a safe and economical liquid form until it needed to be generated or converted into hydrogen gas or, alternatively, this method could form and generate the hydrogen gas in a single step on demand from a safe and economical liquid solution.

### SUMMARY OF THE INVENTION

A system for storing and generating hydrogen of the present invention comprises a solution comprising (a) a photosensitized oxidation product of methanol; and (b) a reduction product of oxygen and a photoreduced photosensitizer, wherein the system generates hydrogen gas when a basic material is added to the solution. Another system for storing and generating hydrogen of this invention comprises a solution comprising the reaction product of (a) a photosensitized oxidation product of methanol; and (b) a reduction product of oxygen and a photoreduced photosensitizer, wherein the system generates hydrogen when a basic material is added to the solution. In a preferred embodiment, the reaction product is bis-(hydroxymethyl) peroxide. In one embodiment, the solution comprises water. In one embodiment, the solution comprises methanol. In one embodiment, the photosensitizer is an anthraquinone. In one embodiment, the basic material comprises an inorganic hydroxide, preferably sodium hydroxide or potassium hydroxide or a combination thereof. In one embodiment, the photosensitizer is dissolved in the solution.

In one embodiment of the systems of this invention, the photosensitizer is in a solid phase in the solution. In one embodiment, the solid phase is a porous membrane comprising a xerogel material and at least a portion of the photosensitizer is complexed to the membrane. In one embodiment, the photosensitizer is an anthraquinone with one or more anionic groups and at least one of the anionic groups is complexed to the xerogel material. In one embodiment, the membrane is a xerogel membrane.

In one embodiment of the systems of the present invention, the photosensitized oxidation product is formaldehyde. In one embodiment, the reduction product of oxygen and the photoreduced photosensitizer is hydrogen peroxide.

One method of the present invention for storing hydrogen comprises the steps of (a) providing a solution comprising methanol; (b) providing a photosensitizer for the oxidation of methanol; (c) providing oxygen gas; and (d) providing light that is absorbed by the photosensitizer, wherein the photosensitizer is dissolved in the solution or is in a solid phase in the solution, wherein the photosensitizer absorbs light and oxidizes the methanol and forms a photoreduced photosensitizer, and further wherein the oxygen gas oxidizes the photoreduced photosensitizer to regenerate the photosensitizer and is reduced to form hydrogen peroxide. In one embodiment, the photosensitized oxidation product of methanol is formaldehyde. In one embodiment, the photosensitized oxidation product of methanol and the hydrogen peroxide react to form a reaction product that generates hydrogen in the presence of a basic material. In one embodiment, the reaction product is bis-(hydroxymethyl) peroxide. In one embodiment, the yield of hydrogen from the reaction product in the presence of the basic material is 100% based on the relative molecular weights of hydrogen and the reaction product.

In one embodiment of the methods of this invention, prior to the formation of the reaction product, the solution is placed into a storage container. In one embodiment, the solid phase is removed from the solution in the storage container subsequent to the formation of the reaction product.

In one embodiment of the methods of the present invention, subsequent to the formation of the reaction product, the solution is placed into a storage container. In one embodiment, the solid phase is removed from the solution in the storage container subsequent to the formation of the reaction product and prior to or after placing the solution into the storage container.

In one embodiment of the methods of this invention, the solution comprises water. In one embodiment, the photosensitizer is an anthraquinone. In one embodiment, the basic material comprises an inorganic hydroxide, preferably sodium hydroxide or potassium hydroxide or a combination thereof. In one embodiment, the photosensitizer is dissolved in the solution.

In one embodiment of the methods of the present invention, the photosensitizer is in a solid phase in the solution. In one embodiment, the solid phase is a porous membrane comprising a xerogel material and at least a portion of the photosensitizer is complexed to the membrane. In one embodiment, the photosensitizer is an anthraquinone with one or more anionic groups and at least one of the anionic groups is complexed to the xerogel material. In one embodiment, the membrane is a xerogel membrane.

### DETAILED DESCRIPTION OF THE INVENTION

The systems and methods of the present invention provide a flexible, safe, and effective approach to storing and generating hydrogen by utilizing a liquid solution that forms precursor products to producing hydrogen and that can generate hydrogen gas immediately upon the formation of the precursor products or, alternatively, can store the precursor products and generate hydrogen gas at a later desired time.

A system for storing and generating hydrogen of the present invention comprises a solution comprising (a) a photosensitized oxidation product of methanol; and (b) a reduction product of oxygen and a photoreduced photosensitizer, wherein the system generates hydrogen gas when a basic material is added to the solution. Another system for storing and generating hydrogen of this invention comprises a solution comprising the reaction product of (a) a photosensitized oxidation product of methanol; and (b) a reduction product of oxygen and a photoreduced photosensitizer, wherein the system generates hydrogen when a basic material is added to the solution. In a preferred embodiment, the reaction product is bis-(hydroxymethyl) peroxide. In one embodiment, the solution comprises water. In one embodiment, the solution comprises methanol. In one embodiment, the photosensitizer is an anthraquinone. In one embodiment, the basic material comprises an inorganic hydroxide, preferably sodium hydroxide or potassium hydroxide or a combination thereof. In one embodiment, the photosensitizer is dissolved in the solution.

The liquid solution of the systems of the present invention comprises a photosensitized oxidation product of methanol. In a preferred embodiment, the photosensitized oxidation product is formaldehyde. The formaldehyde may be present in the liquid solution as a monomer, as a polymer, as part of a reaction product with another material present in the solution such as hydrogen peroxide, or combinations thereof. These chemical states of formaldehyde-related species may be in equilibrium with one or more of the other states and are capable of generating hydrogen gas in combination with the presence of hydrogen peroxide and a basic material, such as sodium hydroxide.

The photosensitized oxidation product of methanol is preferably prepared by oxidizing methanol using a photosensitizer and ultraviolet and/or visible light depending on the wavelengths at which the photosensitizer is effective. Alternatively, the oxidation product of methanol may be made by a non-photolytic oxidation process, such as by a thermal catalytic process. The photosensitized oxidation typically involves a photo-induced abstraction of a hydrogen atom from the methanol that leads to a photoreduced photosensitizer with added hydrogen atoms and to an oxidation product of methanol, typically formaldehyde.

The liquid solution of the systems of this invention also comprises a reduction product of oxygen and a photoreduced photosensitizer. In a preferred embodiment, the reduction product is hydrogen peroxide. By choosing a photosensitizer for oxidizing methanol that becomes reduced by the addition of hydrogen atoms to form a photoreduced photosensitizer and that regenerates the photosensitizer by auto-oxidation with oxygen, a reduction product of oxygen is formed, typically hydrogen peroxide. Since the photosensitizer is regenerated, it acts as a catalyst in producing the oxidation product of methanol and the reduction product of oxygen and is not consumed during the generation of the precursor products for generating hydrogen. Also, if the photosensitizer is present when the hydrogen gas is generated, typically the photosensitizer is unchanged by the chemical reactions that generate the hydrogen gas.

The solution comprising the oxidation product of methanol and the reduction product of oxygen generates hydrogen gas when a basic material is added or comes in contact with the solution. While not wishing to be bound by a particular theory, it is believed that this results from the reaction of the basic material with one or more reaction products of the oxidation product of methanol and the reduction product of oxygen to further oxidize the oxidation product of methanol and to form the further reduced product of hydrogen gas. In one embodiment, the reaction product that generates hydrogen gas is bis-(hydroxymethyl) peroxide, hereinafter referred to as BHMP. BHMP may be formed by the reaction of two molecules of formaldehyde and one molecule of hydrogen peroxide. In the presence of a basic material, BHMP generates hydrogen gas with formate salts as a by-product. BHMP or similar chemical species may be in equilibrium with formaldehyde and hydrogen peroxide and related chemical species, but, in the presence of the basic material, even very small concentrations of BHMP are converted to hydrogen gas and other products. Eventually, all of the formaldehyde and hydrogen peroxide and related chemical species typically form BHMP or similar chemical species through rapid chemical equilibria and result in generation of hydrogen gas with carbon-based by-products such as formate salts that are derived from the original methanol in the solution.

Conversion of methanol to hydrogen and carbon dioxide and other gaseous by-products by steam reforming is well known as, for example, described in U.S. Pat. No. 5,861,137 to Edlund and U.S. Pat. Nos. 5,997,594 and 6,221,117 to Edlund et al. The steam reforming process typically requires high temperatures in the range of 250° C. to 800° C. and purification of the hydrogen gas to remove the carbon dioxide and other by-product gases. The overall methanol to hydrogen conversion of the present invention may be carried out at ambient temperatures and requires no heating. The only energy input required is the light to photosensitize the oxidation of methanol. This could be provided by natural sunlight by, for example, solar exposure of thin layers of the solution in a closed container to prevent evaporation. Alternatively, artificial sources of light powered by electricity could be used. Typically, the photosensitization of the oxidation of methanol is highly efficient with 20% to nearly 100% of the absorbed photons resulting photo-oxidation. The hydrogen produced in the methanol to hydrogen system of this invention is typically very pure and contains no gaseous by-products. Thus, special purification processes for the hydrogen gas product are not required. The carbon-based products of the methanol to hydrogen system are typically formate salts that are not gases and remain in the solution after the hydrogen gas is generated. These carbon-based products can be isolated from the solution by known methods such as, for example, evaporation of the liquid to yield the solid formate salts. To improve the capability of isolating the carbon-based products, the photosensitizer is preferably in a solid phase that may be conveniently removed from the liquid solution after the photolytic part of the system is complete. The formate salts and other carbon-based solid by-products may be utilized in various applications directly or may be modified into another useful material such as, for example, by acidifying the formate salts to produce formic acid. Making formic acid in this way may be useful in supplying fuel cells based on formic acid, particularly if the fuel cell system also uses hydrogen as a feedstock.

The solution may comprise water. Water may be useful in preventing undesirable side reactions of the various oxidation and reduction products, such as formaldehyde, and in providing increased safety to the solution when it is storing the precursor products from which hydrogen gas is generated in the presence of a basic material. The solution may also comprise methanol, in addition to the photosensitized or other oxidation products of methanol that are among the precursor products for generating the hydrogen gas. The methanol may be present simply as some unreacted starting material from the photosensitized oxidation of methanol or may be useful in preventing undesirable side reactions of the various oxidation and reduction products, such as formaldehyde and hydrogen peroxide.

The photosensitizers of the present invention are materials that absorb ultraviolet or visible light and sensitize the photo-oxidation of alcohols such as methanol, ethanol, and 2-propanol. Typically, the photo-oxidation occurs by an initial photo-induced hydrogen abstraction by the photosensitizer of a hydrogen atom on the carbon of the alcohol that is adjacent to the oxygen of the hydroxyl group. The end result is the oxidation of the alcohol to an aldehyde in the case of primary alcohols and to a ketone in the case of secondary alcohols and the reduction of the photosensitizer by the addition of one or more hydrogen atoms. For example, in the case of a 9,10-anthraquinone as the photosensitizer, the photoreduced anthraquinone is a 9,10-diydroxyanthracene. In the presence of oxygen, the 9,10-dihydroxyanthracene is oxidized back to the 9,10-anthraquinone and hydrogen peroxide is formed from the reduction of the oxygen. Suitable anthraquinones include, but are not limited to, 9,10-anthraquinone-2,6-disulfonate disodium salt, 9,10-anthraquinone-2-sulfonate sodium salt, and 2-tert-butyl-9,10-anthraquinone.

The basic material may be any basic material capable of deprotonating an aliphatic alcohol. Preferably, the basic material comprises an inorganic hydroxide. Examples of suitable inorganic hydroxides include, but are not limited to, sodium hydroxide and potassium hydroxide.

In one embodiment of the systems of this invention, the photosensitizer is in a solid phase in the solution. In one embodiment, the solid phase is a porous membrane comprising a xerogel material and at least a portion of the photosensitizer is complexed to the membrane. In one embodiment, the photosensitizer is an anthraquinone with one or more anionic groups and at least one of the anionic groups is complexed to the xerogel material. In one embodiment, the membrane is a xerogel membrane.

By the term “xerogel material”, as used herein, is meant a porous material that was formed by a xerogel or sol gel process of drying a colloidal sol liquid to form a gel solid material. By the term “xerogel membrane”, as used herein, is meant a membrane that comprises at least one layer comprising a xerogel material where the pores of the xerogel material are continuous from one side of the layer to the other side of the layer. Xerogel materials and membranes typically comprise inorganic oxide materials, such as aluminum oxides, aluminum boehmites, and zirconium oxides, as the sol gel materials. Examples of suitable xerogel membranes for the present invention include, but are not limited to, the xerogel membranes described in U.S. Pat. Nos. 6,153,337 and 6,306,545 to Carlson et al. and U.S. Pat. Nos. 6,488,721 and 6,497,780 to Carlson. Since these inorganic oxides, such as aluminum boehmite, have a positively charged metal ion, it has been found that they form complexes with the anionic groups of organic dyes, such as with the sulfonate groups of 9,10-anthraquinone-2,6-disulfonate. It has also been found that the extremely small pore sizes of the xerogel materials and membranes may result in a steric hindrance that allows only one of the two sulfonate groups of 9,10-anthraquinone-2,6-disulfonate to complex to the positively charged metal ion. The other sulfonate group is non-complexed and free to interact with other materials, such as to complex to cationic groups on dyes introduced in liquids into the pores of the xerogel.

In one embodiment of the systems of the present invention, the photosensitized oxidation product is formaldehyde. In one embodiment, the reduction product of oxygen and the photoreduced photosensitizer is hydrogen peroxide.

One method of the present invention for storing hydrogen comprises the steps of (a) providing a solution comprising methanol; (b) providing a photosensitizer for the oxidation of methanol; (c) providing oxygen gas; and (d) providing light that is absorbed by the photosensitizer, wherein the photosensitizer is dissolved in the solution or is in a solid phase in the solution, wherein the photosensitizer absorbs light and oxidizes the methanol and forms a photoreduced photosensitizer, and further wherein the oxygen gas oxidizes the photoreduced photosensitizer to regenerate the photosensitizer and is reduced to form hydrogen peroxide. In one embodiment, the photosensitized oxidation product of methanol is formaldehyde. In one embodiment, the photosensitized oxidation product of methanol and the hydrogen peroxide react to form a reaction product that generates hydrogen in the presence of a basic material. In one embodiment, the reaction product is bis-(hydroxymethyl) peroxide. In one embodiment, the yield of hydrogen from the reaction product in the presence of the basic material is 100% based on the relative molecular weights of hydrogen and the reaction product.

While not wishing to be bound by a particular theory, it is believed that the precursor oxidation and reduction products that lead to hydrogen generation are in rapid equilibrium with one or more chemical species that react quantitatively in the presence of a basic material to produce hydrogen gas. For example, the molecular weight of hydrogen is 2, and the molecular weight of BHMP, one example of the reaction product of this invention, is 94. Thus, a 100% yield of hydrogen gas from BHMP would be about 2.1% of the weight of the BHMP. If the amount of the precursor oxidation and reduction products are converted into the total equivalent amount of BHMP that they would produce, a 100% yield of hydrogen gas would be about 2.1% of this total equivalent amount.

Since this invention includes the use of the solution to store precursor products from which to generate hydrogen gas on demand, it is important that the liquid solution be stored in a suitable storage container. For example, the storage container could be an underground storage tank, the storage tank in a vehicle, or a storage container for a fuel cell. It may be useful to make the precursor products in one container and then transfer the liquid solution to a storage container designed for the particular application, such as an underground tank for a fueling station for vehicles or the fuel tank in the vehicle. For other applications, the liquid solution could be placed in the container in which the precursor products are made and stored and either immediately or later activated with a basic material to generate hydrogen gas. In one embodiment of the methods of this invention, prior to the formation of the reaction product, the solution is placed into a storage container. In one embodiment, the solid phase is removed from the solution in the storage container subsequent to the formation of the reaction product. The solid phase typically contains the photosensitizer which acts as a catalyst and is reusable and is not needed for the final hydrogen gas generation step. Thus, the solid phase can be removed from the liquid solution at any time after its use in producing the precursor products is completed.

In one embodiment of the methods of the present invention, subsequent to the formation of the reaction product, the solution is placed into a storage container. In one embodiment, the solid phase is removed from the solution in the storage container subsequent to the formation of the reaction product and prior to or after placing the solution into the storage container.

In one embodiment of the methods of this invention, the solution comprises water. In one embodiment, the photosensitizer is an anthraquinone. In one embodiment, the basic material comprises an inorganic hydroxide, preferably sodium hydroxide or potassium hydroxide or a combination thereof. In one embodiment, the photosensitizer is dissolved in the solution.

In one embodiment of the methods of the present invention, the photosensitizer is in a solid phase in the solution. In one embodiment, the solid phase is a porous membrane comprising a xerogel material and at least a portion of the photosensitizer is complexed to the membrane. In one embodiment, the photosensitizer is an anthraquinone with one or more anionic groups and at least one of the anionic groups is complexed to the xerogel material. In one embodiment, the membrane is a xerogel membrane.

While the invention has been described in detail and with reference to specific and general embodiments thereof, it will be apparent to one skilled in the art that various changes and modifications can be made therein without departing from the spirit and scope thereof.

What is claimed is:

1. A system for storing and generating hydrogen comprising a solution comprising
(a) a photosensitized oxidation product of methanol, and
(b) a reduction product of oxygen and a photoreduced photosensitizer,
wherein said system generates hydrogen gas when a basic material is added to said solution.

2. The system of claim 1, wherein said solution comprises water.

3. The system of claim 1, wherein said solution comprises methanol.

4. The system of claim 1, wherein said photosensitizer is an anthraquinone.

5. The system of claim 1, wherein said basic material comprises an inorganic hydroxide.

6. The system of claim 1, wherein said basic material comprises sodium hydroxide or potassium hydroxide or a combination thereof.

7. The system of claim 1, wherein said photosensitizer is dissolved in said solution.

8. The system of claim 1, wherein said photosensitizer is in a solid phase in said solution.

9. The system of claim 1, wherein said photosensitized oxidation product is formaldehyde.

10. The system of claim 1, wherein said reduction product of oxygen and said photoreduced photosensitizer is hydrogen peroxide.

11. A system for storing and generating hydrogen comprising a solution comprising the reaction product of
(a) a photosensitized oxidation product of methanol, and
(b) a reduction product of oxygen and a photoreduced photosensitizer,
wherein said system generates hydrogen when a basic material is added to said solution.

12. The system of claim 11, wherein said reaction product is bis-(hydroxymethyl) peroxide.

13. The system of claim 11, wherein said solution comprises water.

14. The system of claim 11, wherein said solution comprises methanol.

15. The system of claim 11, wherein said photosensitizer is an anthraquinone.

16. The system of claim 11, wherein said basic material comprises an inorganic hydroxide.

17. The system of claim 11, wherein said basic material comprises sodium hydroxide or potassium hydroxide or a combination thereof.

18. The system of claim 11, wherein said photosensitizer is dissolved in said solution.

19. The system of claim 11, wherein said photosensitizer is in a solid phase in said solution.

20. The system of claim 11, wherein said photosensitized oxidation product is formaldehyde.

21. The system of claim 11, wherein said reduction product of oxygen and said photoreduced photosensitizer is hydrogen peroxide.

22. A method for storing hydrogen, said method comprising the steps of:
(a) providing a solution comprising methanol,
(b) providing a photosensitizer for the oxidation of methanol,
(c) providing oxygen gas, and
(d) providing light that is absorbed by said photosensitizer,
wherein said photosensitizer is dissolved in said solution or is in a solid phase in said solution, wherein said photosensitizer absorbs light and oxidizes said methanol and forms a photoreduced photosensitizer, and further wherein said oxygen gas oxidizes said photoreduced photosensitizer to regenerate said photosensitizer and is reduced to form hydrogen peroxide.

23. The method of claim 22, wherein the photosensitized oxidation product of methanol is formaldehyde.

24. The method of claim 22, wherein the photosensitized oxidation product of methanol and said hydrogen peroxide react to form a reaction product that generates hydrogen in the presence of a basic material.

25. The method of claim 24, wherein said reaction product is bis-(hydroxymethyl) peroxide.

26. The method of claim 24, wherein the yield of said hydrogen from said reaction product in the presence of said basic material is 100% based on the relative molecular weights of hydrogen and said reaction product.

27. The method of claim 24, wherein, prior to the formation of said reaction product, said solution is placed into a storage container.

28. The method of claim 27, wherein said solid phase is removed from said solution in said storage container subsequent to the formation of said reaction product.

29. The method of claim 24, wherein, subsequent to the formation of said reaction product, said solution is placed into a storage container.

30. The method of claim 29, wherein said solid phase is removed from said solution in said storage container subsequent to the formation of said reaction product and prior to or after placing said solution into said storage container.

31. The method of claim 22, wherein said solution comprises water.

32. The method of claim 22, wherein said photosensitizer is an anthraquinone.

33. The method of claim 24, wherein said basic material comprises an inorganic hydroxide.

34. The method of claim 24, wherein said basic material comprises sodium hydroxide or potassium hydroxide or a combination thereof.

35. The method of claim 22, wherein said photosensitizer is dissolved in said solution.

36. The method of claim 22, wherein said photosensitizer is in a solid phase in said solution.
